(19) United States
(12) Patent Application Publication
(10) Pub. No.: US 2006/0055117 A1
(43) Pub. Date: Mar. 16, 2006

(54) Arrangement for a sensor and its wire connections in a mulitple-plate metal cylinder-head gasket

(75) Inventor: Frederic Pepin, Limoges (FR)

Correspondence Address: HARNESS, DICKEY & PIERCE, P.L.C., P.O. BOX 828, BLOOMFIELD HILLS, MI, 48303, US

(73) Assignee: CARL FREUDENBERG KG, Weinheim (DE)

(21) Appl. No.: 10/520,443

(22) PCT Filed: Jun. 30, 2003
(86) PCT No.: PCT/EP03/06922

§ 371 Date: Jul. 12, 2005

(30) Foreign Application Priority Data
Jul. 8, 2002 (FR) 0208527

(51) Int. Cl. F16J 15/00

(52) U.S. Cl. 277/317

(57) ABSTRACT

An arrangement for a multilayer cylinder head gasket comprising at least two plates, one lower and one upper, with ribs, a base plate and an intermediate plate containing a sensor disposed in the immediate vicinity of the edge of the cylinder orifice and wires for transmitting the information provided by the sensor, characterized in that it consists of accommodating a baffle between the base plate and the intermediate plate for the passage of the wires along the baffle.

### CROSS-REFERENCE TO RELATED APPLICATIONS

This application is a National Stage of International Application No. PCT/EP2003/006922, filed Jun. 30, 2003. This application claims the benefit of French patent application 0208527, filed Jul. 8, 2002. The disclosures of the above applications are incorporated herein by reference.

### FIELD OF THE INVENTION

The present invention relates to the arrangement of a sensor and of its wire connections in a metallic multiplayer cylinder head gasket.

### BACKGROUND OF THE INVENTION

Internal combustion engines are becoming more and more potent and more and more controlled in terms of both the fabrication of the pieces that constitute them and their operation once they have been mounted and placed into service.

As a result, combustion is an important aspect not only from the standpoint of improving the efficiency and performance of these engines, but also from that of limiting pollution.

One arrives at this result by carefully determining the quantities of fuel and combustion supporter, the torque, the point of introduction and the circulation before and after explosion, by limiting the dead zones, by controlling with high accuracy the heights of the gasket and, in particular, by controlling the explosion.

The fuels themselves have been improved.

A number of these parameters depend on the operating conditions of the engine, such as the external air temperature, the temperature of the fuel-air mixture before it enters the combustion chamber, the engine temperature, the temperature of the exhaust gas, and all the engine load parameters that depend on the vehicle load and the kind of driving.

Numerous sensors are available for measuring these parameters and for transmitting them to a data acquisition and control unit by fibers or by independent wires or through a bus.

These sensors are of a known type. They are disposed at different spots of the engine and in places provided in the engine block and in the cylinder head to sense from the outside different fluid circuits.

On the other hand, what is not available are the parameters that are most important to know, for example the temperature and pressure inside the combustion chamber, nor are there any indications of the oscillations of the cylinder head compared to the engine block or of the variations in sealing tightness or fatigue of the head cylinder gasket or of changes in its elasticity constants with time.

It is, however, precisely this area in which it is advantageous to accurately measure all these parameters if one wants to ensure improved and more accurate driving. This would tend toward an optimization of the combustion cycle efficiency and reduced pollution by limiting the volume of unburned exhaust substances. On the other hand, the problems lies in placing one or more sensors in the immediate proximity of each combustion chamber of an internal combustion engine, namely in direct contact with the internal volume of the combustion chamber, knowing that the chamber must remain perfectly closed and that none of the sensors must cause a change in mechanical parameters and, in particular, must not require excessive thickness.

An attractive localization that makes it possible to meet these requirements is in the cylinder head gasket. The cylinder head gasket is a perfect interface because of its placement relative to the combustion chamber.

Moreover, modification of the cylinder head gasket and the adaptation of a sensor are not easy to do, but they can be done. In the case of the engine block, however, the difficulty is to achieve subsequently a tightly sealed passage.

This is in fact where the greatest problem arises, because once a sensor is put in place it must be possible to connect it to the data acquisition and control unit which necessarily requires the use of a fiber or a wire.

### SUMMARY OF THE INVENTION

The arrangement according to the present invention makes it possible to use the cylinder head gasket as the site for implanting at least one sensor regardless of the physical parameter measured, and it proposes a solution for the passage of fibers or wires.

In the following description, the term wire will be used to indicate indifferently a conductor based on an electric wire made of copper enveloped by a thermally and electrically insulating covering or one or more optical fibers also enveloped by a thermally and electrically insulating covering or else a flat, flexible printed conductor.

In fact, to be able to connect the wire to the data acquisition and control unit, it must be possible to make the wire pass through the cylinder head gasket of the combustion chamber all the way to the periphery of the gasket.

To prevent the wire from being damaged, the wire must not be subjected to pressures arising from the tightening of the cylinder head gasket and it must not interfere with the primary function of the gasket, namely providing a tight seal between the cylinder head and the engine block.

Patent applications are known in which attempts are made to find a solution to this problem, but these attempts have been unsatisfactory.

For example, in Japanese patent application JP-91958814, the cylinder head gasket used is a multilayer gasket. A sensor is provided which is disposed in the immediate proximity of the edge of the cylinder orifice. The wires themselves are disposed in a recess provided in the thickness of a first plate of the gasket. A compressible material integral with a second plate is superposed on this recess to keep the wires in their place.

U.S. Pat. No. 5,659,132 discloses a system of sensors that makes it possible to measure the parameters in the combustion chamber, the signal output being measured outside the engine block. The cylinder head gasket is used to permit the passage of the connecting wires. The means used consist of a rigid tube having a diameter greater than that of the conductor or conductors lodged therein, the empty surrounding space being filled with an insulating material. Such an arrangement is satisfactory but requires machining of the pieces that face each other to form recesses capable of receiving each tube. This is expensive and requires great precision incompatible with industrial fabrication in large series.

The arrangement according to the present invention will now be described in detail for a preferred embodiment and its variants.

### BRIEF DESCRIPTION OF THE DRAWINGS

This description refers to the attached drawings in which the different figures represent the following:

FIG. 1 shows a view in perspective of a part of the multilayer cylinder head gasket with a sensor and a superposition of certain layers;

FIG. 2 shows an exploded view of elements constituting the part of the multilayer cylinder head gasket with a sensor of FIG. 1;

FIG. 3 shows a cross-sectional view of a part of the multilayer cylinder head gasket with a sensor such as that shown in FIG. 1;

FIG. 4 shows a view in perspective of a variant of a part of the multilayer cylinder with a sensor and a superposition of certain layers;

FIG. 5 shows a cross-sectional view of the part of the gasket of FIG. 4; and

FIG. 6 shows an exploded view of different elements of the part of the gasket of FIGS. 4 and 5.

### DETAILED DESCRIPTION OF THE PREFERRED EMBODIMENTS

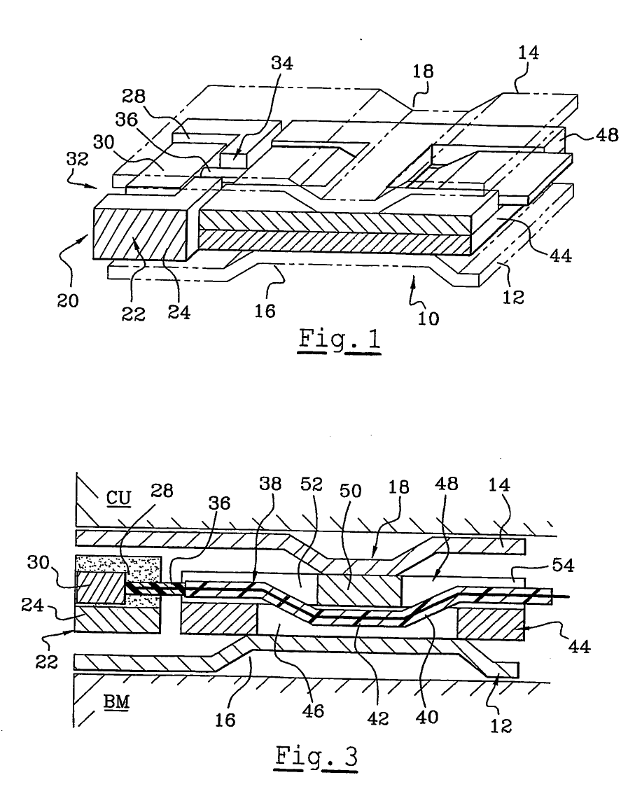

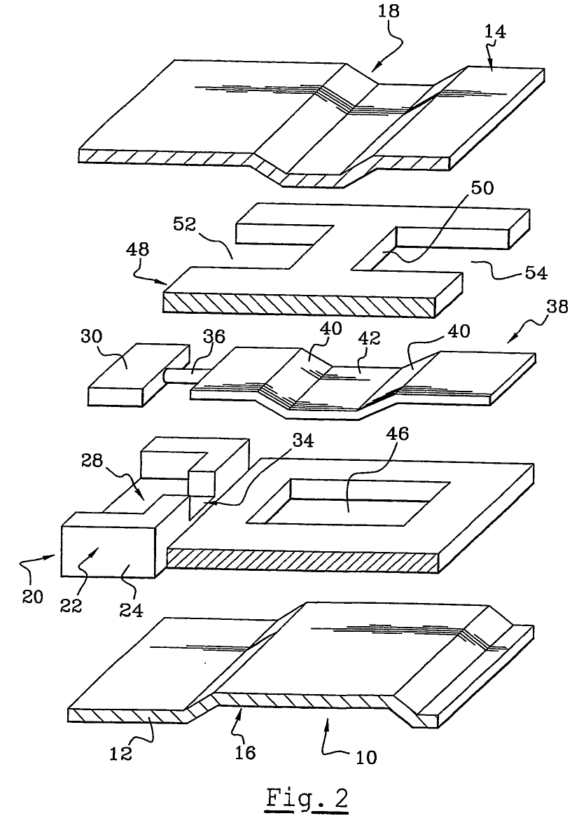

In FIG. 1 is represented a part of a cylinder head gasket 10 of the multilayer kind. The layers comprise two plates, namely a lower plate 12 and an upper plate 14. In this case, each plate 12 and 14 is provided with a rib 16 and 18, respectively. On a side of the cylinder orifice 20 is provided a peripheral stopper 22 that is interposed between the lower plate 12 and the upper plate 14.

The stopper 22 is made of a single piece 24, either in a foundry or by machining, and is provided with a seat 28. The seat 28 can be obtained by any means, such as casting, embossing, machining or stamping. The total height results in a thickness E.

A sensor 30 is disposed in the seat and rests on or is integrated with the lower plate 12. On one of its sides 32, the seat 28 is advantageously open toward the cylinder orifice 20 and opens into the combustion chamber. Thus, the sensor 30 can be in direct contact with the environment prevailing in the chamber, which makes it possible to measure different parameters depending on the nature of the sensor 30.

Seat 28 also has a passage 34 for wires 36 that faces the open side 32. The wires 36 are connected to the sensor 30. The wires 36 comprise an extension possibly in a flat covering 38 which, for example, is molded and which has a double-baffle cross-section. The cross-section can also be defined as being U-shaped with open branches 40 and a flat bottom 42.

The cylinder head gasket 10 of minimum configuration also comprises a base plate 44 to which is attached the stopper 22. The base plate 4 in this first embodiment is preferably mounted in a floating fashion.

The base plate 44 has a window 46 opposite the wires 36 of the sensor 30, and is aligned with the seat 28.

The dimensions of the window 46 are such that it is able to receive the double baffle of the branches 40 and the bottom 42. Thickness e1 of the base plate 44 is greater than the thickness of the wires 36 including their covering 38.

On the base plate 44 is disposed an inserted (intermediate) plate 48. The inserted plate 48 comprises a bridge 50 and two open windows 52 and 54 that are disposed on the two sides of the bridge 50.

The two windows 52 and 54 are oriented so as to be above the wires 36 of the sensor 30 and more particularly its covering 38.

The bridge 50 is disposed so as to be above the flat bottom 42 which allows the two branches 40 to extend on the two sides of the bridge 50.

A thickness e2 of the intermediate plate 48 is greater than the thickness of the wires 36 including their covering 38.

The sum of thickness e1 of the base plate 44 and thickness e2 of the intermediate plate 48 is less than the thickness E of the stopper 22.

Note that in the particular arrangement of the invention, represented in cross-section in FIG. 3, the rib 16 of the lower plate 12 touches the base plate 44 in a manner that blocks window 46, and that the rib 18 of the upper plate 14 touches the bridge 50.

It can be seen that with such an arrangement the wires 36 and their covering 38, if any, pass through the double-baffle channel resulting from the geometry of the various pieces constituting the cylinder head gasket 10.

This arrangement does not interfere with tight sealing in the zone that is of interest from the stand-point of the present invention, because the remainder of the gasket surface is subject the usual rules and associated behavior.

In fact, it can be seen that the stopper 22 absorbs the tightening stresses arising between engine block BM and the cylinder head CU. The lower plate 12 and the upper plate 14 ensure a tight seal opposite the stopper 22 in the zone of the sensor 30. Preferably, a filling material is added around the sensor 30 in the seat 28, on the one hand to immobilize it and, on the other, to ensure that the first tightness barrier is as effective as possible.

As for the second tightness barrier, it is also provided opposite the ribs 16 and 18. Thus, the rib 16 of the lower plate 12 presses against the base plate 44, and the rib 18 presses against the upper plate 14.

It can also be seen that the wires 36 are not subjected to compression.

To fill in the free volumes around the wires 36 and to ensure support for them, it is possible to intro-duce a polymer, preferably one of the heat-resistant elastomer type.

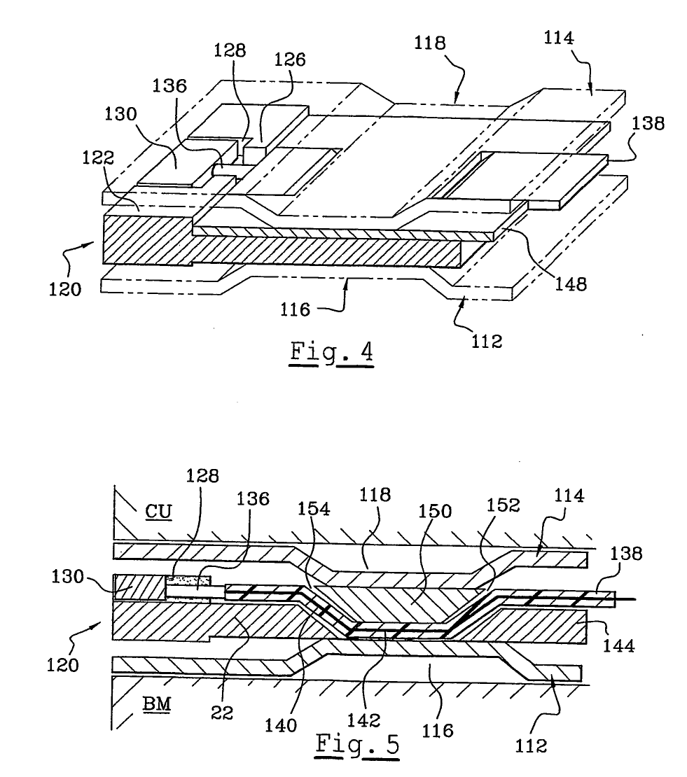

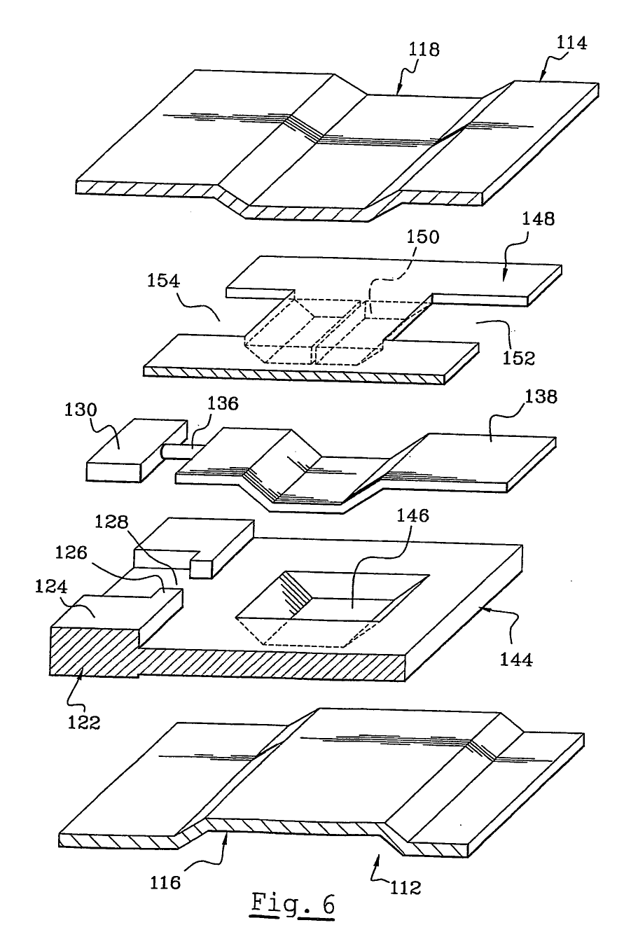

FIGS. 4, 5 and 6 show an embodiment wherein identical elements and those having the same function bear the same reference numeral increased by 100.

In this embodiment, the base plate 44 is a thick plate with the stopper 122 integrated therewith, namely providing a monolithic assembly. The base plate 44 comprises a window 146 essentially identical to window 46 except that the support edges for wires 136 with a covering 138 on the window 146 are beveled.

An intermediate plate 154 is a thin plate to ensure that the total thickness is less than the thickness opposite the stopper 22, as in the previous case. The thickness of the intermediate plate 154 is approximately equal to that of the wires 136.

Opposite the double baffle, opposite flat bottom 142, the intermediate plate 154 comprises a projecting bridge 150, the profile of which approximately corresponds to that of the window 146 of the base plate 44.

The mounting is identical to the previous one, and it is advantageous to adapt the profile of ribs 116 and 118 so as to ensure that the pressure stresses are properly applied to the lower and upper plate.

In this arrangement, as specifically shown in FIG. 4, with the assembly mounted, the wires with the passage along the baffle are not exposed to any risk of being crushed even in the long term because they do not come in contact with any element.

Tight sealing is respected, and the gasket can fulfill its primary function between the engine block and the cylinder head.

Note that the industrial fabrication of such plates is made easier. The products shown schematically in the figures must be adapted by those skilled in the art so that the complementary cutting is made immediately at the time of stamping of the completed layer even though the arrangement according to the invention does not require any supplementary operation.

Note also that the objective of the present invention is attained, because the wires emerge from the cylinder head gasket into the thickness of which they are embedded thus transmitting the information provided by the sensor to a data acquisition and treatment unit, and this without ever being subjected to compression that could create degradations.

In the case where the wires are optical fibers, the radius of curvature opposite the baffle is compatible with the authorized curvature radii and does not disturb the information carried by said fibers. The edges of the various windows and seats can be beveled or flared out depending on the need.

1. An arrangement of a multilayer cylinder head gasket comprising:
an upper plate and a lower plate, each plate including a pair of;
a base plate;
an intermediate plate comprising a sensor disposed in an immediate vicinity of an edge of a cylinder orifice; and
wires for transmitting information provided by the sensor,
wherein a baffle is disposed between the base plate and the intermediate plate for the passage of the wires along the baffle.

2. The arrangement of a multilayer cylinder head gasket according to claim 1, wherein the base plate comprises a window opposite the wires of the sensor, and the intermediate plate comprises a bridge and two open windows disposed on each side of the bridge

3. The arrangement of a multilayer cylinder head gasket according to claim 2, wherein the bridge is disposed so as to position itself above the wires passing along the baffle with a flat bottom and two branches.

4. The arrangement of a multilayer cylinder head gasket according to claim 3, wherein a thickness of the intermediate plate is greater than a thickness of the wires, and the bridge is in a plane of the intermediate plate.

5. The arrangement of a multilayer cylinder head gasket according to claim 3, wherein the thickness of the intermediate plate is approximately equal to a thickness of the wires, and the bridge forms a projection in the window of the base plate.

6. The arrangement of a multilayer cylinder head gasket according to claim 1, further comprising a stopper disposed between the ribs of the upper and lower plates and opposite the base plate and the intermediate plate, wherein a height E of the stopper is greater than a sum of a heights e1 of the base plate and a height e2 of the intermediate plate.

7. The arrangement of a multilayer cylinder head gasket according to claim 6, wherein the stopper comprises a seat for receiving the sensor, the seat being open on one side toward the cylinder orifice and comprising a passage.

8. The arrangement of a multilayer cylinder head gasket according to claim 7, wherein a plurality of free spaces around the sensor in the seat are filled.

9. The arrangement of a multilayer cylinder head gasket according to claim 6, wherein the stopper is mounted so as to float relative to the upper and lower plates.
